(19) United States
(12) Patent Application Publication
(10) Pub. No.: US 2015/0130712 A1
(43) Pub. Date: May 14, 2015

(54) OPERATION INTERFACE DEVICE AND OPERATION INTERFACE METHOD

(71) Applicant: Masato Hirai, Tokyo (JP)

(72) Inventor: Masato Hirai, Tokyo (JP)

(73) Assignee: MITSUBISHI ELECTRIC CORPORATION, Tokyo (JP)

(21) Appl. No.: 14/397,935

(22) PCT Filed: Aug. 10, 2012
(86) PCT No.: PCT/JP2012/005102

§ 371 Date: Oct. 30, 2014

(51) Int. Cl. G06F 3/0481; G06F 3/0488; G06F 3/0482; G06F 3/0484; G06F 3/02; G06F 3/041

(52) U.S. Cl. CPC G06F 3/04812; G06F 3/0227; G06F 3/0412; G06F 3/0416; G06F 3/0482; G06F 3/04842; G06F 3/04883
USPC 345/157; 345/173

(57) ABSTRACT

There are provided a touch panel 3 that is mounted on the display surface of a handy operational display 2, a rotary dial 4 that accepts a remote operation, and a touch detector 5 that detects a touch of an operator to the rotary dial 4. An image display unit 10 displays, when the touch of the operator is not detected with the touch detector 5, a touch panel operational image suitable for the operation of the touch panel 3 on a liquid crystal display 1 and handy operational display 2, and displays when the touch of the operator is detected with the touch detector 5, a rotary dial operational image suitable for the operation of the rotary dial 4 on the liquid crystal display 1 and handy operational display 2.

### TECHNICAL FIELD

The present invention relates to an operation interface device and an operation interface method, which operation interface device employs as an onboard operation device a plurality of operational interfaces (such as a touch panel, rotary dial, remote control etc.) jointly.

### BACKGROUND ART

As an onboard operation device, there is an operation interface device that uses remote operation devices (such as a rotary dial and a remote control) jointly in addition to a touch panel.

Although it is necessary for the operation of a remote operation device that a cursor indicating a currently selectable operation item is displayed on a display, when an operator operates using a touch panel, the display of a cursor is unnecessary, and the display of the cursor is rather bothersome.

Accordingly, an operation interface device disclosed in the following Patent Document 1 conceals a cursor when detecting an output signal of a remote control which is a remote operation device, thereby solving the bother.

However, the arrangement itself of an image displayed on the display does not change even if the output signal of the remote control is detected.

### PRIOR ART DOCUMENT

### Patent Document

Patent Document 1: Japanese Patent Laid-Open No. 2005-332190 (Paragraph No. [0034], for example).

### DISCLOSURE OF THE INVENTION

### Problems to be Solved by the Invention

With the foregoing configuration, the conventional operation interface device displays a cursor when detecting the output signal of the remote control which is a remote operation device. However, it displays the same image on the display regardless of whether the operation is performed with the remote operation device or with the touch panel. Accordingly, if the arrangement of the image displayed on the display has an image arrangement suitable for the operation of the remote operation device, it is likely that the image arrangement is unsuitable for the operation of the touch panel, and on the contrary if the image arrangement displayed on the display is suitable for the operation of the touch panel, it is likely that the image arrangement is unsuitable for the operation of the remote operation device. Accordingly, it has a problem in that one of the operability of the touch panel and the operability of the remote operation device is sacrificed.

In addition, although it displays the cursor when detecting the output signal of the remote control which is the remote operation device, it is necessary for an operator to perform an idle operation (an operation only for displaying the cursor, which is a wasteful switch operation different from the operation of selecting a desired item) of the remote control to detect the output signal of the remote control, which offers a problem of making it not easy to handle.

The present invention is implemented to solve the foregoing problems. Therefore it is an object of the present invention to provide an operation interface device and an operation interface method capable of improving the operability of the touch panel and remote operation device.

Another object of the present invention is to provide an operation interface device capable of displaying the cursor without causing the operator to carry out the idle operation of the remote operation device.

### Means for Solving the Problems

An operation interface device in accordance with the present invention comprises: a display that displays an image; a touch panel that is mounted on a display surface of the display; a remote operation device that accepts a remote operation; and a touch detector that detects a touch of an operator to the remote operation device, wherein an image display unit displays, when the touch of the operator is not detected with the touch detector, a touch panel operational image suitable for an operation of the touch panel on the display, and displays, when the touch of the operator is detected with the touch detector, a remote operation device operational image suitable for the operation of the remote operation device on the display.

### Advantages of the Invention

According to the present invention, it is configured in such a manner that the image display unit displays, when the touch of the operator is not detected with the touch detector, a touch panel operational image suitable for an operation of the touch panel on the display, and displays, when the touch of the operator is detected with the touch detector, a remote operation device operational image suitable for the operation of the remote operation device on the display. Accordingly, it offers an advantage of being able to improve the operability of the touch panel and remote operation device.

### BRIEF DESCRIPTION OF THE DRAWINGS

FIG. 1 is a block diagram showing a configuration of an operation interface device of an embodiment 1 in accordance with the present invention;

FIG. 2 is a flowchart showing processing contents (operation interface method) of the operation interface device of the embodiment 1 in accordance with the present invention;

FIG. 3 is a diagram showing a structure of a rotary dial 4;

FIG. 4 is a view illustrating an example of an image displayed on a liquid crystal display 1;

FIG. 5 is a view illustrating an example of an image displayed on a handy operational display 2;

FIG. 6 is a table showing correspondence of an image displayed on the liquid crystal display 1 to an operation device (touch panel 3 and rotary dial 4) and operation target information;

FIG. 7 is a table showing correspondence of the operation target information to image arrangement information (arrangement information of touch panel operational image, and arrangement information of rotary dial operational image (remote operation device operational image));

FIG. 8 is a view illustrating an example of an image displayed on the liquid crystal display 1 (touch panel operational image and rotary dial operational image);

FIG. 9 is a view illustrating an example of an image displayed on the handy operational display 2 (touch panel operational image and rotary dial operational image);

FIG. 10 is a view showing a display example on the liquid crystal display 1 when a touchpad is installed instead of the handy operational display 2 and touch panel 3;

FIG. 11 is a view illustrating an example of an image displayed on the liquid crystal display 1 (touch panel operational image and rotary dial operational image);

FIG. 12 is a view illustrating an example of an image displayed on the handy operational display 2 (touch panel operational image and rotary dial operational image);

FIG. 13 is a view illustrating an example of an image displayed on the liquid crystal display 1 (touch panel operational image and rotary dial operational image);

FIG. 14 is a view illustrating an example of an image displayed on the handy operational display 2 (touch panel operational image and rotary dial operational image);

FIG. 15 is a view illustrating an example of an image displayed on the liquid crystal display 1 (touch panel operational image and rotary dial operational image);

FIG. 16 is a view illustrating an example of an image displayed on the handy operational display 2 (touch panel operational image and rotary dial operational image);

FIG. 17 is a view illustrating an example of an image displayed on the liquid crystal display 1 (touch panel operational image and rotary dial operational image);

FIG. 18 is a view illustrating an example of an image displayed on the handy operational display 2 (touch panel operational image and rotary dial operational image);

FIG. 19 is a view illustrating an example of an image displayed on the liquid crystal display 1 (touch panel operational image and rotary dial operational image);

FIG. 20 is a view illustrating an example of an image displayed on the handy operational display 2 (touch panel operational image and rotary dial operational image);

FIG. 21 is a view illustrating an example of an image displayed on the liquid crystal display 1 (touch panel operational image and rotary dial operational image);

FIG. 22 is a view illustrating an example of an image displayed on the handy operational display 2 (touch panel operational image and rotary dial operational image);

FIG. 23 is a block diagram showing a configuration of an operation interface device of an embodiment 3 in accordance with the present invention;

FIG. 24 is a diagram showing an operation example of a remote control with a joystick;

FIG. 25 is a diagram showing an operation example of a remote control with a joystick;

FIG. 26 is a block diagram showing a configuration of an operation interface device of an embodiment 4 in accordance with the present invention;

FIG. 27 is a block diagram showing a configuration of an operation interface device of an embodiment 5 in accordance with the present invention; and

FIG. 28 is a perspective view showing an induction cooker to which the operation interface device of an embodiment 6 in accordance with the present invention is applied.

### BEST MODE FOR CARRYING OUT THE INVENTION

The best mode for carrying out the invention will now be described with reference to the accompanying drawings to explain the present invention in more detail.

### Embodiment 1

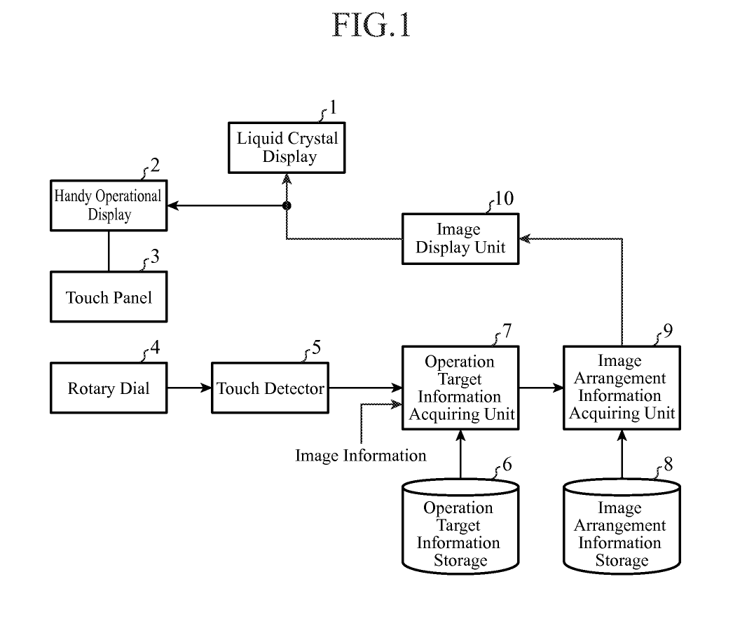

FIG. 1 is a block diagram showing a configuration of an operation interface device of an embodiment 1 in accordance with the present invention.

In FIG. 1, a liquid crystal display 1, which is installed at a position beyond the reach of an operator (such as in a dashboard of a vehicle when the operation interface device is mounted as an onboard operation device), is a large-sized display that displays an image including a map of navigation or audio information. Incidentally, the liquid crystal display 1 constitutes a first display.

A handy operational display 2, which is placed within reach of an operator (mounted on the console or steering wheel of the vehicle when the operation interface device is mounted as an onboard operation device, for example), is a display that displays roughly the same image as the image displayed on the display 1 (part of an image displayed on the liquid crystal display 1). Incidentally, the handy operational display 2 constitutes a second display.

A touch panel 3, which is mounted on the display surface of the handy operational display 2, is an operational interface that accepts an operation by detecting the position at which the operator touches.

A rotary dial 4, which is placed within reach of the operator (mounted on the console or steering wheel of the vehicle when the operation interface device is installed as an onboard operation device, for example), is a remote operation device that accepts a remote operation.

Although the present embodiment 1 is described by way of example that incorporates the rotary dial 4 as the remote operation device, the remote operation device is not limited to the rotary dial 4. For example, it can be an operation device such as a remote control, joystick, or touchpad.

A touch detector 5, which is comprised of an electric conductor, for example, detects a touch of the operator to the rotary dial 4. Incidentally, the touch detector 5 constitutes a touch detector.

Although an example is shown here in which the touch detector 5 is comprised of an electric conductor, any touch detectors will do as long as they can detect a touch of the operator to the rotary dial 4. For example, it can be comprised of an infrared sensor.

When the touch detector is comprised of an infrared sensor, the touch of the operator is detected by the fact that infrared rays received by the infrared sensor are blocked by a hand of the operator when the hand of the operator approaches the rotary dial 4.

An operation target information storage 6, which is comprised of a storage medium such as a RAM and hard disk, stores the correspondence of the image displayed on the liquid crystal display 1 at present to the operation device (touch panel 3, rotary dial 4) and the operation target information.

An operation target information acquiring unit 7, which is comprised of a semiconductor integrated circuit incorporating a CPU or of a single-chip microcomputer, for example, receives the image information indicating the image displayed on the liquid crystal display 1 at present, and executes, when the touch of the operator is not detected with the touch detector 5, the processing that acquires from the operation target information storage 6 the image which is designated by the image information and is in display, and the operation target information corresponding to the touch panel 3.

On the other hand, when the touch of the operator is detected with the touch detector 5, the operation target information acquiring unit 7 executes the processing that acquires from the operation target information storage 6 the image which is designated by the image information and is in display, and the operation target information corresponding to the rotary dial 4.

An image arrangement information storage 8, which is comprised of a storage medium such as a RAM and a hard disk, stores the correspondence of the operation target information to the image arrangement information (the arrangement information of a touch panel operational image and the arrangement information of a rotary dial operational image (remote operation device operational image)).

An image arrangement information acquiring unit 9, which is comprised of a semiconductor integrated circuit incorporating a CPU or of a single-chip microcomputer, executes the processing of acquiring from the image arrangement information storage 8 the image arrangement information corresponding to the operation target information acquired by the operation target information acquiring unit 7.

An image display unit 10, which is comprised of a semiconductor integrated circuit incorporating a CPU or of a single-chip microcomputer, for example, executes the processing that displays, when the image arrangement information acquired by the image arrangement information acquiring unit 9 is the arrangement information of the touch panel operational image, the touch panel operational image on the liquid crystal display 1 and handy operational display 2 in accordance with the image arrangement information, and that displays, when the image arrangement information is the arrangement information of the rotary dial operational image, the rotary dial operational image on the liquid crystal display 1 and handy operational display 2 in accordance with the image arrangement information.

Incidentally, the operation target information storage 6, operation target information acquiring unit 7, image arrangement information storage 8, image arrangement information acquiring unit 9 and image display unit 10 constitute an image display unit.

Although it is assumed in FIG. 1 that the components of the operation interface device, that is, the liquid crystal display 1, handy operational display 2, touch panel 3, rotary dial 4, touch detector 5, operation target information storage 6, operation target information acquiring unit 7, image arrangement information storage 8, image arrangement information acquiring unit 9 and image display unit 10 are each comprised of dedicated hardware, all of or part of the operation interface device can be comprised of a computer.

For example, when part of the operation interface device (the operation target information storage 6, operation target information acquiring unit 7, image arrangement information storage 8, image arrangement information acquiring unit 9, and image display unit 10) is comprised of a computer, a configuration is possible in which the operation target information storage 6 and image arrangement information storage 8 are constructed on the internal memory or external memory of the computer, and programs describing the processing contents of the operation target information acquiring unit 7, image arrangement information acquiring unit 9 and image display unit 10 are stored in the memory of the computer so that the CPU of the computer executes the programs stored in the memory.

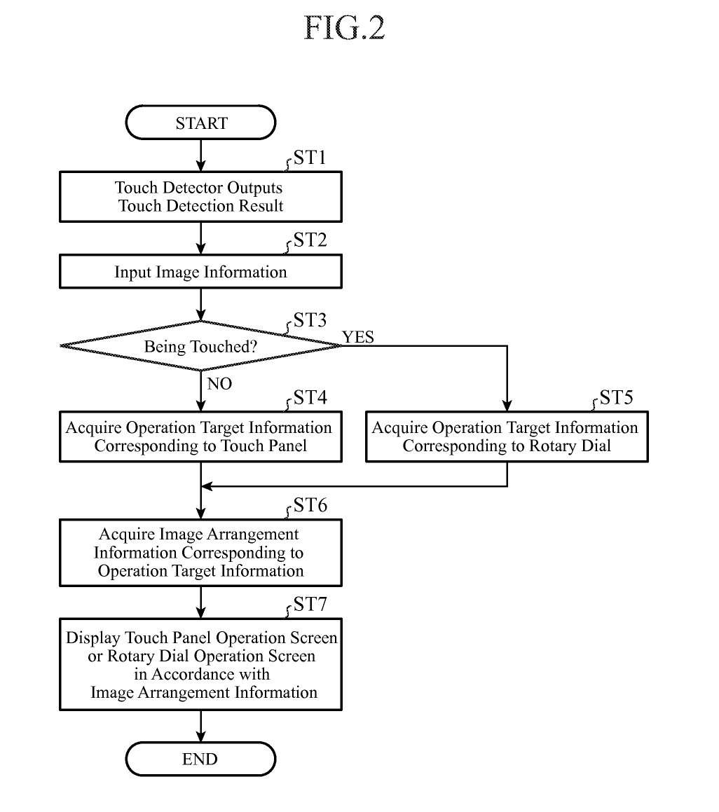

FIG. 2 is a flowchart showing the processing contents (operation interface method) of the operation interface device of the embodiment 1 in accordance with the present invention.

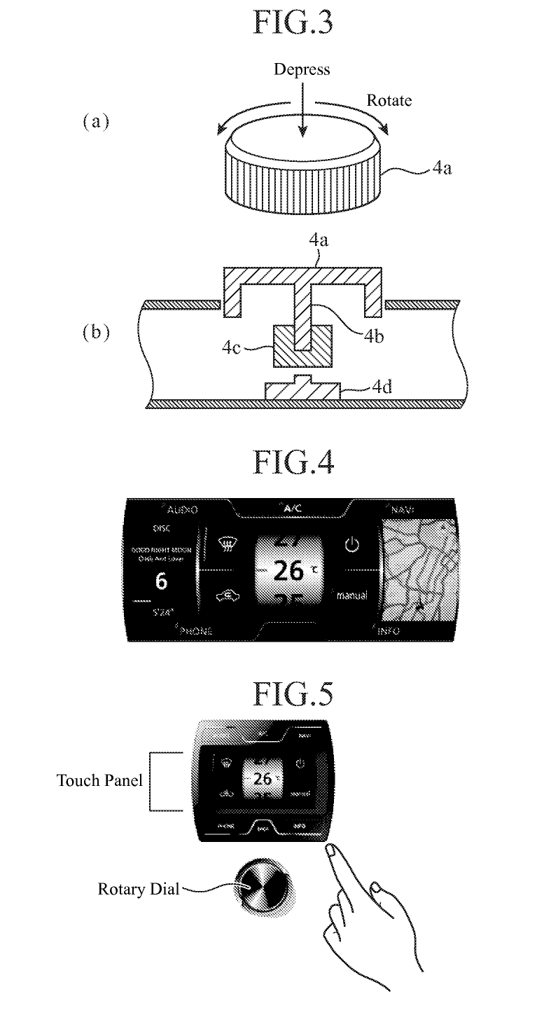

FIG. 3 is a diagram showing a structure of the rotary dial 4.

In the example of FIG. 3, the rotary dial 4 is comprised of a knob 4a, a touch sensor 4b, a rotary encoder 4c and a push switch 4d.

The knob 4a is a part that is grasped by the hand when an operator operates the rotary dial 4. The touch sensor 4b, which is a component corresponding to the touch detector 5, detects a touch of the operator to the rotary dial 4.

Although the touch detector 5 is incorporated into the rotary dial 4 as the touch sensor 4b in the example of FIG. 3, the touch detector 5 can be a sheet-like device consisting of an electric conductor and is mounted in such a manner as to cover the surface of the rotary dial 4, for example.

Next, the operation will be described.

FIG. 4 is a view illustrating an example of an image displayed on the liquid crystal display 1, and FIG. 5 is a view illustrating an example of an image displayed on the handy operational display 2.

The example of FIG. 4 displays an image showing the information about audio, the information about air-conditioning, and a navigation map.

The example of FIG. 5 displays only the information about the air-conditioning out of the display contents of the liquid crystal display 1.

In addition, in the example of FIG. 5, the rotary dial 4 is mounted at the position directly under the handy operational display 2.

For example, when the touch detector 5 is comprised of an electric conductor or the like, a current will flow through the electric conductor when the operator touches the rotary dial 4.

If the touch detector 5 detects that a current flows through the electric conductor, it detects a touch of the operator to the rotary dial 4 by that fact. Accordingly, unless it detects that a current flows through the electric conductor, it does not detect the touch of the operator to the rotary dial 4.

The touch detector 5 supplies the operation target information acquiring unit 7 with a detection result of the touch of the operator to the rotary dial 4 (step ST1 of FIG. 2).

The operation target information acquiring unit 7 receives as its input the image information about the image displayed on the liquid crystal display 1 at present (step ST2).

If the detection result output from the touch detector 5 indicates that the operator does not touch the rotary dial 4 (step ST3), the operation target information acquiring unit 7 acquires from the operation target information storage 6 the image which is designated by the image information and is in display, and the operation target information corresponding to the touch panel 3 (step ST4).

If the detection result output from the touch detector 5 indicates that the operator touches the rotary dial 4 (step ST3), the operation target information acquiring unit 7 acquires from the operation target information storage 6 the image which is designated by the image information and is in display, and the operation target information corresponding to the rotary dial 4 (step ST5).

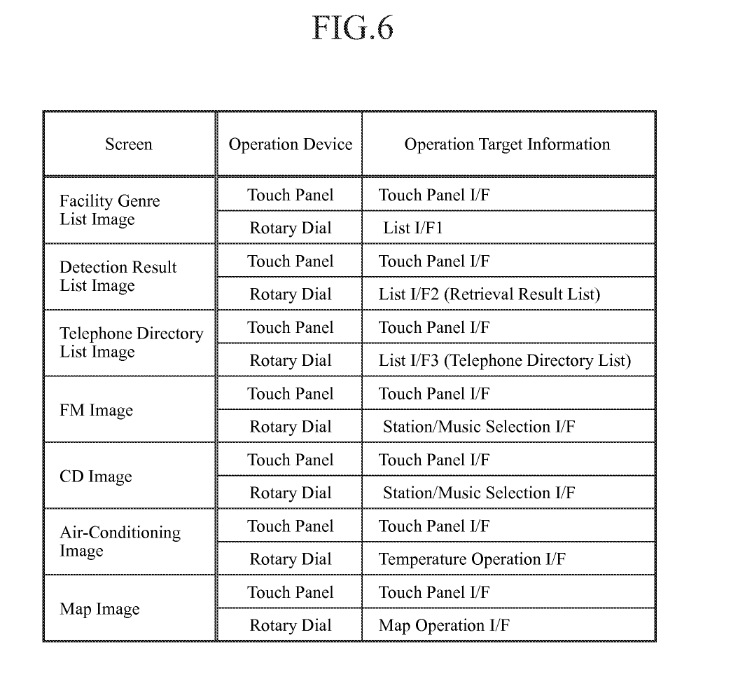

Here, FIG. 6 is a table showing correspondence of the image displayed on the liquid crystal display 1 to the operation device (touch panel 3 and rotary dial 4) and to the operation target information.

When the detection result output from the touch detector 5 indicates that the operator touches the rotary dial 4, the operator is expected to operate the rotary dial 4. Accordingly, when the image displayed on the liquid crystal display 1 at present is a facility genre list, for example, the operation target information acquiring unit 7 obtains a “list I/F1” as the operation target information. In addition, if the image displayed on the liquid crystal display 1 at present is a retrieval result list, it acquires a “list I/F2 (retrieval result list)” as the operation target information.

On the other hand, if the detection result output from the touch detector 5 indicates that the operator does not touch the rotary dial 4, the operator is expected to operate the touch panel 3. Accordingly, if the image displayed on the liquid crystal display 1 at present is a facility genre list, for example, the operation target information acquiring unit 7 obtains a “touch panel I/F” as the operation target information.

When the operation target information acquiring unit 7 acquires the operation target information, the image arrangement information acquiring unit 9 acquires the image arrangement information corresponding to the operation target information from the image arrangement information storage 8 (step ST6).

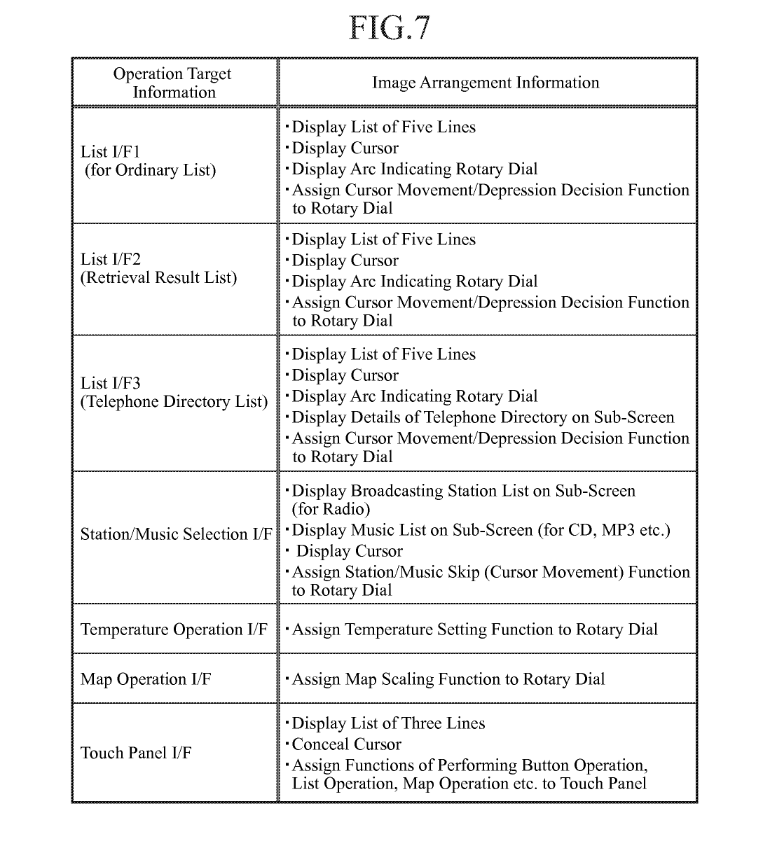

Here, FIG. 7 is a table showing the correspondence of the operation target information to the image arrangement information (the arrangement information of the touch panel operational image and the arrangement information of the rotary dial operational image (remote operation device operational image)).

For example, if the operation target information acquired by the operation target information acquiring unit 7 is the “list I/F1”, the image arrangement information acquiring unit 9 acquires four pieces of the arrangement information as the arrangement information of the rotary dial operational image.
The list is “5 line display”.
The cursor is to be “displayed”
Display a circular arc indicating the rotary dial.
Assign to the rotary dial a cursor move function and a decision function of an item the cursor indicates.

In addition, if the operation target information acquired by the operation target information acquiring unit 7 is the “touch panel I/F”, the image arrangement information acquiring unit 9 acquires three pieces of the arrangement information as the arrangement information of the touch panel operational image.
The list is “3 line display”
The cursor is “concealed”
Assign to the touch panel 3 a function of performing the button operation, list operation or map operation.

When the image arrangement information acquiring unit 9 acquires the image arrangement information, and if the image arrangement information is the arrangement information of the touch panel operational image, the image display unit 10 displays the touch panel operational image on the liquid crystal display 1 and the handy operational display 2 in accordance with the image arrangement information.

If the image arrangement information is the arrangement information of the rotary dial operational image, the image display unit 10 displays the rotary dial operational image on the liquid crystal display 1 and handy operational display 2 in accordance with the image arrangement information (step ST7).

Incidentally, when the operator takes his or her hand off the rotary dial 4 (if the touch detector 5 does not detect the touch of the operator to the rotary dial 4 anymore) after displaying the rotary dial operational image on the liquid crystal display 1 and handy operational display 2, and after a fixed time has elapsed, the image display unit 10 displays the touch panel operational image on the liquid crystal display 1 and handy operational display 2.

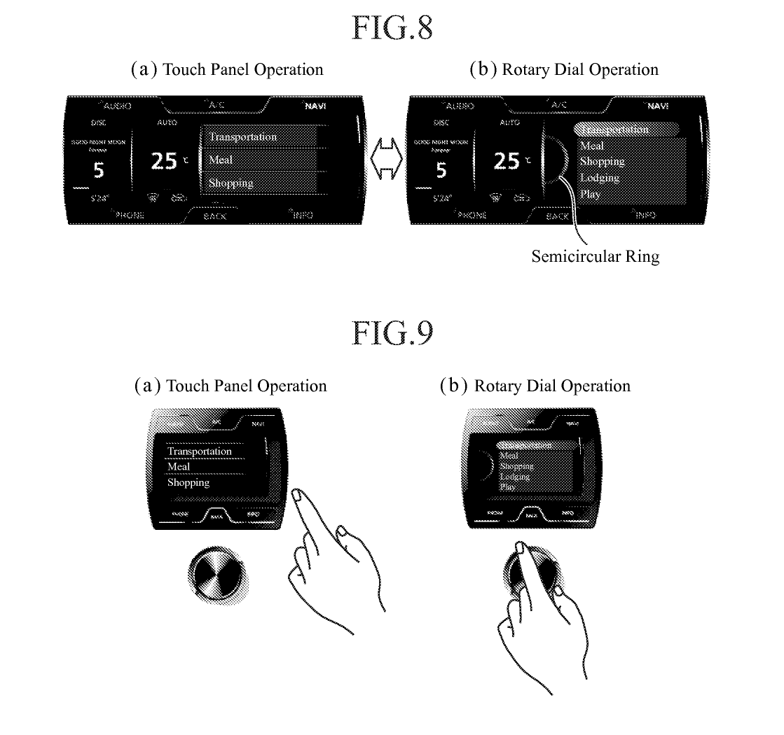

FIG. 8 is a view illustrating an example of an image displayed on the liquid crystal display 1: FIG. 8(a) shows a touch panel operational image; and FIG. 8(b) shows a rotary dial operational image.

In addition, FIG. 9 is a view illustrating an example of an image displayed on the handy operational display 2: FIG. 9(a) shows a touch panel operational image; and FIG. 9(b) shows a rotary dial operational image.

As shown in FIG. 8(a) and FIG. 9(a), the touch panel operational images display a three-line list with a wider vertical spacing that makes it easier for the operator to touch, and conceal the cursor.

As shown in FIG. 8(b) and FIG. 9(b), the rotary dial operational images display a five-line list that makes it easier to list, and display the cursor that indicates a selectable operation item.

In addition, in the rotary dial operational images, a semicircular ring that suggests the rotary dial 4 is displayed to make it easier to intuitively understand the direction of the cursor movement involved in the rotation of the rotary dial 4. In this connection, rotating the rotary dial 4 in the right direction will move the cursor downward.

As is clear from the foregoing description, according to the present embodiment 1, it is configured in such a manner as to comprise the liquid crystal display 1 that displays an image; the handy operational display 2 that displays roughly the same image as the image displayed on the liquid crystal display 1; the touch panel 3 that is mounted on the display surface of the handy operational display 2; the rotary dial 4 that accepts a remote operation; and the touch detector 5 that detects a touch of the operator to the rotary dial 4, wherein the image display unit 10 displays, when the touch of the operator is not detected with the touch detector 5, the touch panel operational image suitable for an operation of the touch panel 3 on the liquid crystal display 1 and the handy operational display 2, and displays, when the touch of the operator is detected with the touch detector 5, the rotary dial operational image suitable for the operation of the rotary dial 4 on the liquid crystal display 1 and handy operational display 2. Accordingly, it offers an advantage of being able to improve the operability of the touch panel 3 and rotary dial 4.

In addition, according to the present embodiment 1, the image display unit 10 displays the cursor indicating the currently selectable operation item on the liquid crystal display 1 and handy operational display 2 when displaying the rotary dial operational image, and conceals the cursor when displaying the touch panel operational image. Accordingly, when displaying the rotary dial operational image, it offers an advantage of being able to conceal the cursor without performing the idle operation of the rotary dial 4 by the operator.

Although the present embodiment 1 shows the operation interface device comprising the liquid crystal display 1 as well as the handy operational display 2, it is also applicable to an operation interface device without comprising the liquid crystal display 1.

In this case, the image display unit 10 displays, when the touch of the operator is not detected with the touch detector 5, a touch panel operational image suitable for the operation of the touch panel 3 on the handy operational display 2, and displays, when the touch of the operator is detected with the touch detector 5, a rotary dial operational image suitable for the operation of the rotary dial 4 on the handy operational display 2.

In this case also, it can improve the operability of the touch panel 3 and rotary dial 4.

Although the present embodiment 1 shows the operation interface device that comprises the liquid crystal display 1 and the handy operational display 2 and that has the touch panel 3 mounted on the display surface of the handy operational display 2, it can be an operation interface device that comprises a touchpad instead of the handy operational display 2 and touch panel 3.

In this case, the image display unit 10 displays, when the touch of the operator (touch to the rotary dial 4) is not detected with the touch detector 5, a touchpad operational image identical to the touch panel operational image on the liquid crystal display 1, and displays, when the touch of the operator (touch to the rotary dial 4) is detected with the touch detector 5, the rotary dial operational image on the liquid crystal display 1.

In this case, it offers an advantage of being able to improve the operability of the touchpad and the rotary dial 4.

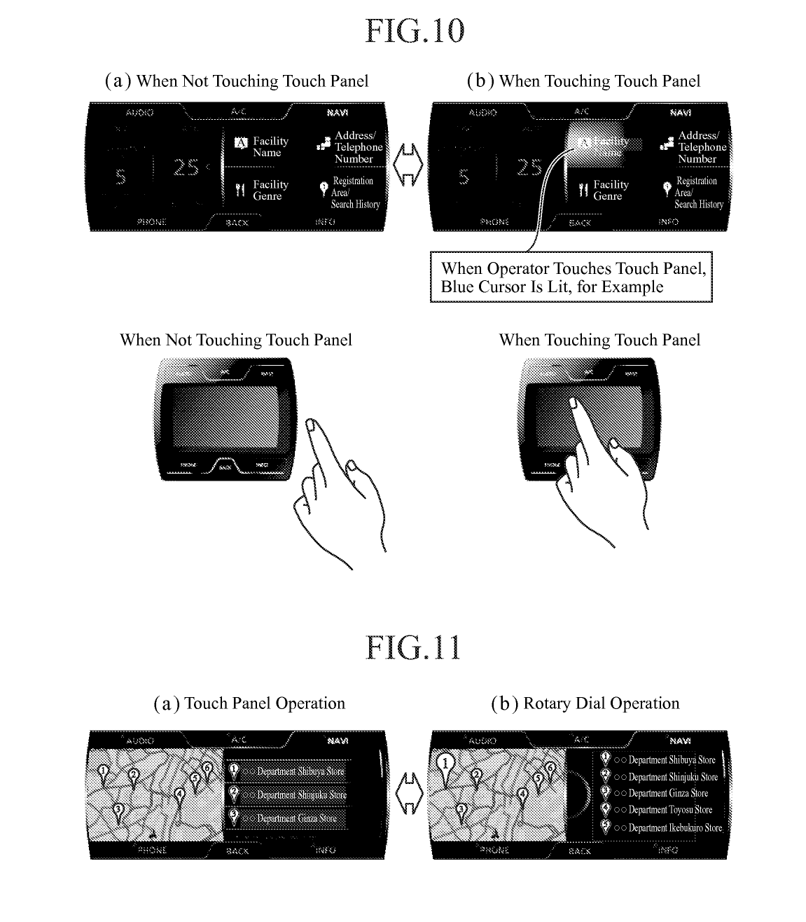

Here, FIG. 10 is a view showing a display example of the liquid crystal display 1 when the touchpad is incorporated instead of the handy operational display 2 and touch panel 3.

FIG. 10(a) shows an example in which a touch of the operator (touch to the rotary dial 4) is not detected with the touch detector 5, and a touchpad operational image that is identical to the touch panel operational image is displayed on the liquid crystal display 1. In contrast, as shown in FIG. 10(b), when the operator touches the touchpad, the liquid crystal display 1 displays the cursor at the position the operator touches.

In FIG. 10(b), since the operator touches the position corresponding to the facility name, the facility name is placed in a selectable state and the facility name is lit by a blue cursor.

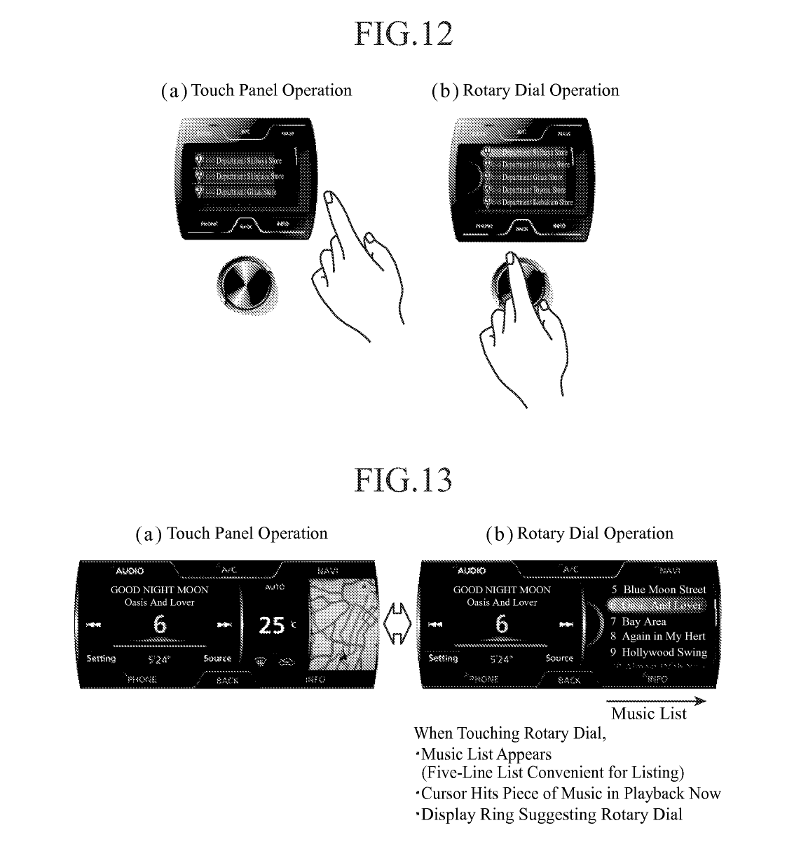

Although the present embodiment 1 shows FIG. 8 and FIG. 9 as a display example of the touch panel operational image and rotary dial operational image, FIG. 11 and FIG. 12 show another display example.

FIG. 11 and FIG. 12 show a display of a retrieval result of facilities by a navigation system, and particularly, facility positions retrieved are displayed on the left side of the screen of the liquid crystal display 1.

At this time, in FIG. 11(b), the facility of a first retrieval result, which is indicated by the cursor in the list, is displayed with a mark greater than the other facilities (the facility shown by the cursor is displayed with emphasis).

The handy operational display 2 displays only the display contents on the right side of the screen of the liquid crystal display 1.

Incidentally, FIG. 12(a) shows the touch panel operational image, and FIG. 12(b) shows the rotary dial operational image.

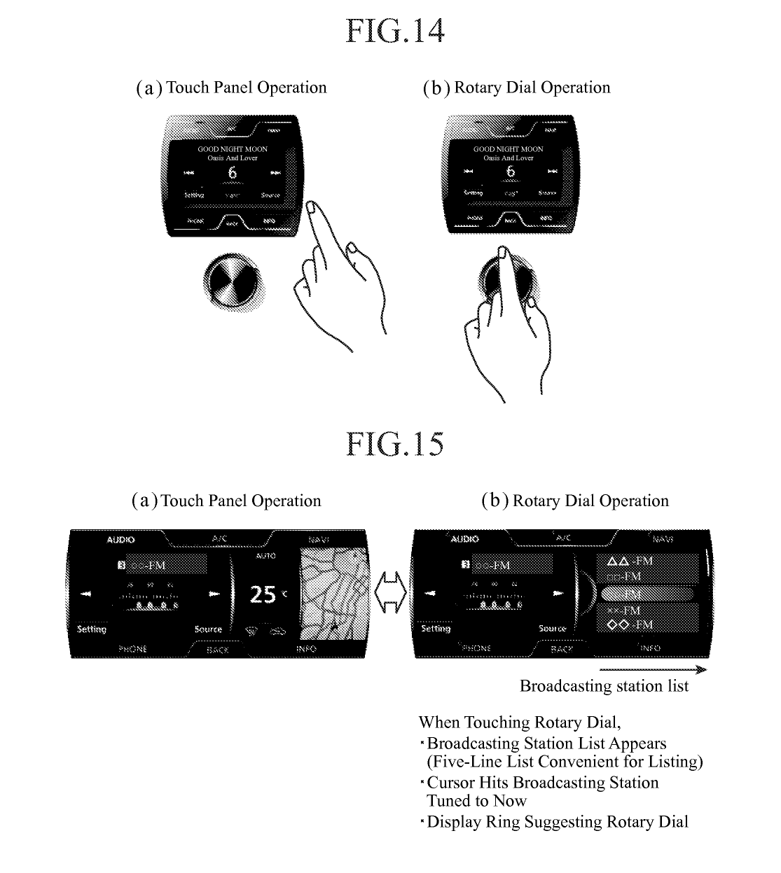

In addition, FIG. 13 and FIG. 14 show another display example.

In FIG. 13 and FIG. 14, which show audio information (information about a CD), music information in performance now is displayed on the left side of the screen of the liquid crystal display 1.

In this case, as shown in FIG. 14(a), the handy operational display 2 displays a touch panel operational image including a previous track button and a next track button, and other buttons (Setting and Source), which enables skipping to the previous track or next track with a touch operation.

On the other hand, the rotary dial 4 is provided with a track skip (cursor move) function which enables skipping to the previous track or next track by the operation of the rotary dial 4 as shown in FIG. 14(b).

Incidentally, a list of tracks recorded on a CD is displayed in the rotary dial operational image (image of FIG. 13(b)) displayed on the liquid crystal display 1.

In FIG. 14(a) and FIG. 14(b), although the image arrangement is shown which enables a user to select the previous track or next track, a list of tracks recorded on a CD can be displayed on the handy operational display 2.

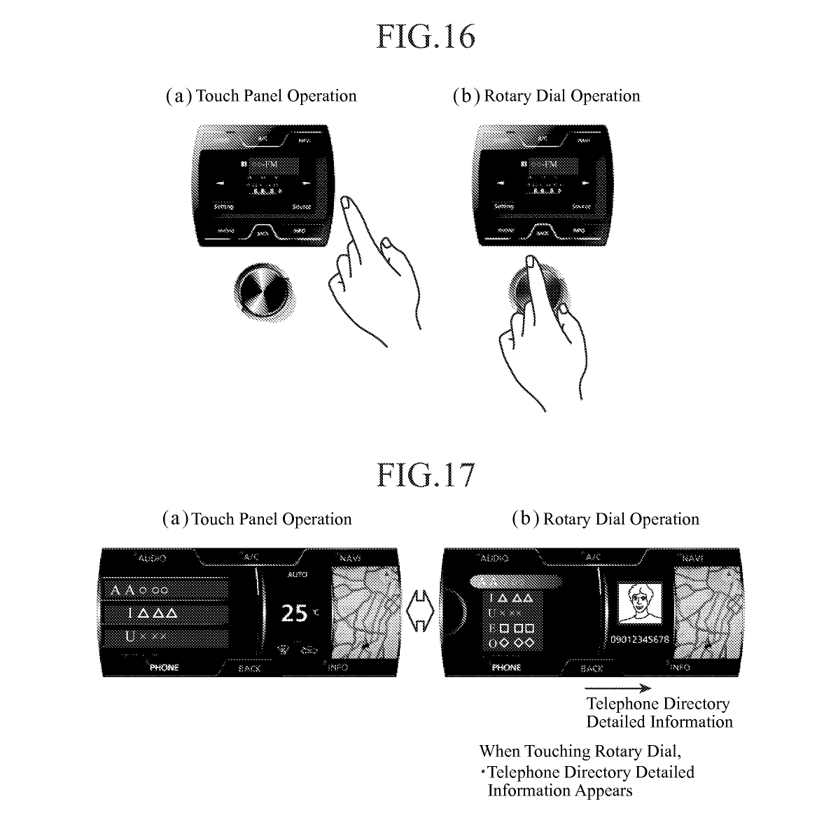

In addition, FIG. 15 and FIG. 16 show another display example.

In FIG. 15 and FIG. 16, which show audio information (radio information), a radio program of a broadcasting station tuned to at present is display on the left side of the screen of the liquid crystal display 1.

At this time, as shown in FIG. 16(a), the handy operational display 2 displays a touch panel operational image including a previous station button and a next station button of radio broadcasting stations and other buttons (Setting and Source), and enables skipping to the previous station or next station with a touch operation.

On the other hand, the rotary dial 4 is provided with a station skip (cursor move) function which enables skipping to the previous station or next station of the radio broadcasting stations by the operation of the rotary dial 4 as shown in FIG. 16(b).

Incidentally, a list of radio broadcasting stations is displayed in the rotary dial operational image (image of FIG. 15(b)) displayed on the liquid crystal display 1.

In FIG. 16(a) and FIG. 16(b), although the image arrangement is shown which enables a user to select the previous station or next station, a list of radio broadcasting stations can be displayed on the handy operational display 2.

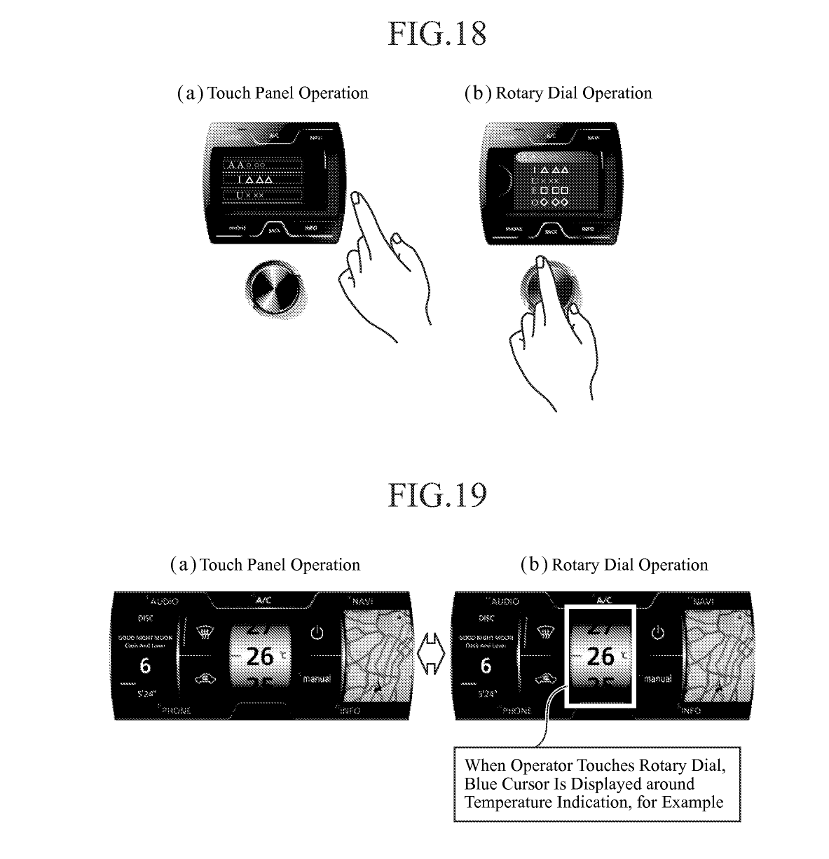

In addition, FIG. 17 and FIG. 18 show another display example.

In FIG. 17 and FIG. 18 which show a telephone directory or the like, names of persons whose phone numbers are registered are displayed on the left side of the screen of the liquid crystal display 1.

At this time, as shown in FIG. 18(a), the handy operational display 2 displays a list of a telephone directory, which enables a user to select a person to be called with a touch operation.

In addition, the rotary dial 4 is provided with a name skip (cursor move) function which enables the name skip by the operation of the rotary dial 4 as shown in FIG. 18(b).

Incidentally, telephone directory detailed information (such as a phone number and a picture of that person) is displayed in the rotary dial operational image (image of FIG. 17(b)) which is displayed on the liquid crystal display 1.

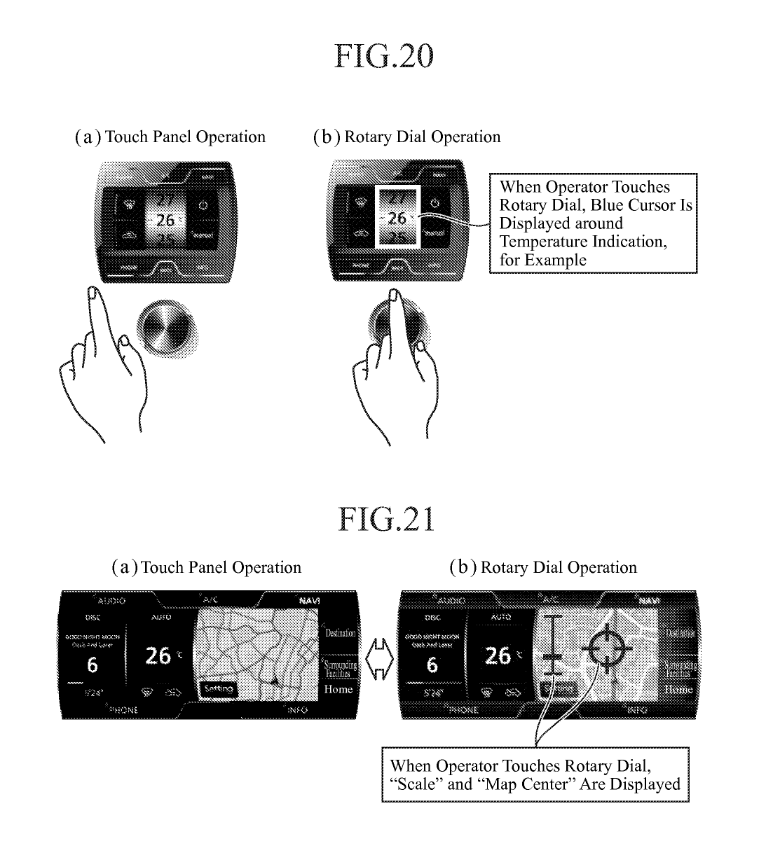

In addition, FIG. 19 and FIG. 20 show another display example.

In FIG. 19 and FIG. 20, which show the information about air-conditioning or the like, the temperature setting of an air-conditioning apparatus is displayed at the center of the screen of the liquid crystal display 1.

At this time, as shown in FIG. 20(a), the handy operational display 2 displays a touch panel operational image that enables the temperature setting with a touch operation.

In addition, the rotary dial 4 is provided with the temperature setting (cursor move) function which enables the temperature setting by the operation of the rotary dial 4 as shown in FIG. 20(b).

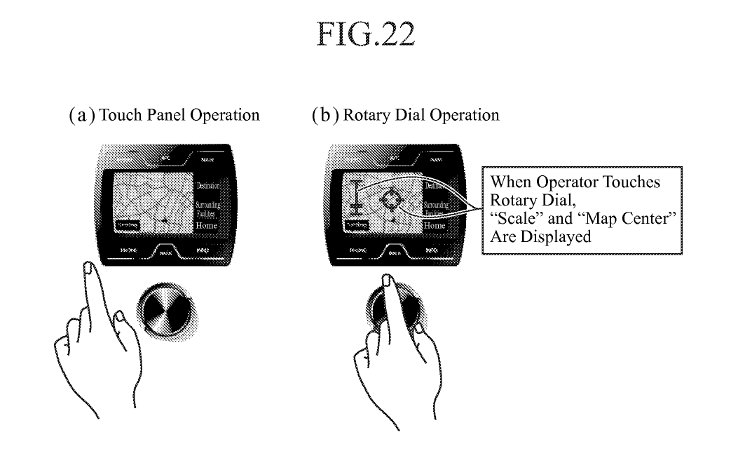

In addition, FIG. 21 and FIG. 22 show another display example.

In FIG. 21 and FIG. 22, which show map information or the like, a map is displayed on the liquid crystal display 1.

At this time, as shown in FIG. 22(a), the handy operational display 2 displays a touch panel operational image that enables setting of one's destination, surrounding facilities, one's house, Setting, scrolling of a map, scaling of the map with a touch operation.

In addition, the rotary dial 4 is provided with a scaling function of a map which enables the scaling of a map by the operation of the rotary dial 4 as shown FIG. 22(b).

Incidentally, when the operator touches the rotary dial 4, a “scale” and a “center mark of the map” are displayed on the liquid crystal display 1 as shown in FIG. 21(b).

### Embodiment 2

Although the foregoing embodiment 1 shows the configuration in which the touch detector 5 detects the touch of the operator to the rotary dial 4 by detecting a current flowing through the electric conductor, a configuration is also possible in which even an operator does not touch the rotary dial 4, the touch detector 5 outputs a detection result indicating that the operator touches the rotary dial 4 if the rotary dial 4 and the operator are close enough to each other, that is, the distance between them is not greater than a prescribed value.

For example, when the touch detector 5 is comprised of a capacitance touch sensor, if the distance between the rotary dial 4 and the operator becomes not greater than a prescribed value, the capacitance of the touch sensor exceeds a prescribed value, thereby enabling detecting the approach of the operator to the rotary dial 4.

Since the processing contents on and after the processing of the operation target information acquiring unit 7 are the same as those of the foregoing embodiment 1, the detailed description of them is omitted.

As is clear from the foregoing description, according to the present embodiment 2, it is configured in such a manner that even if the operator does not touch the remote operation device, if the rotary dial 4 and the operator are close enough to each other, that is, if the distance between them is less than the prescribed value, the touch detector 5 outputs the detection result indicating the touch of the operator to the rotary dial 4. Accordingly, even if the operator does not actually touch the rotary dial 4, if it is highly probable that the operator will touch, it offers an advantage of being able to display the rotary dial operational image suitable for the operation of the rotary dial on the liquid crystal display 1 and handy operational display 2.

### Embodiment 3

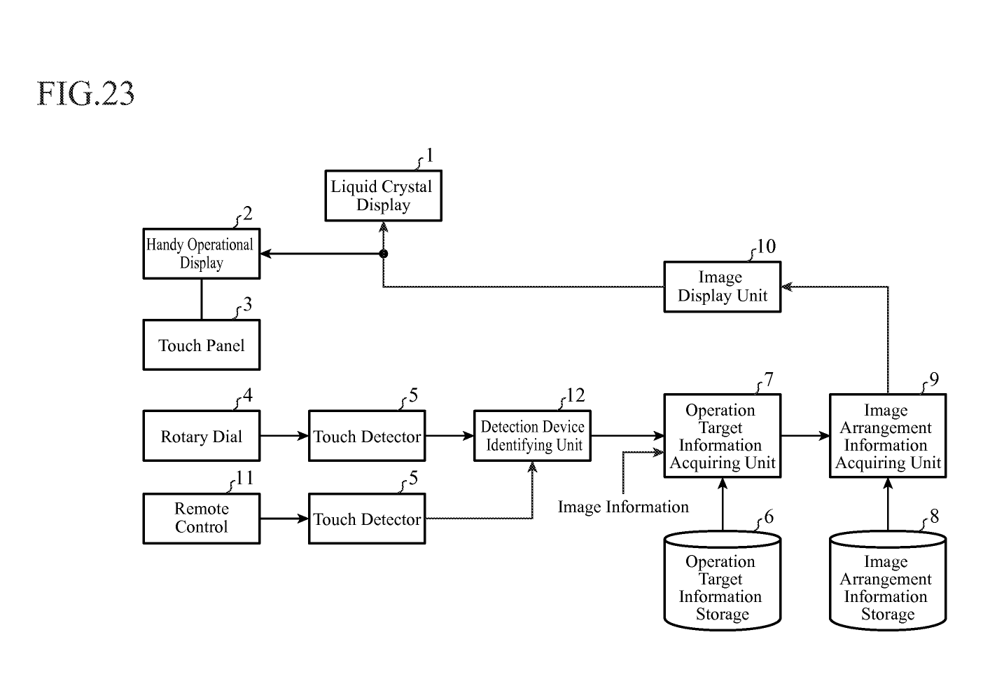

FIG. 23 is a block diagram showing a configuration of an operation interface device of an embodiment 3 in accordance with the present invention. In FIG. 23, since the same reference numerals as those of FIG. 1 designates the same or like components, their description will be omitted.

A remote control 11 is a remote operation device that accepts a remote operation.

In the present embodiment 3, an example will be described which comprises a plurality of remote operation devices (the rotary dial 4 and the remote control 11). A combination of the plurality of remote operation devices, however, is not limited to a combination of the rotary dial 4 and the remote control 11, but a combination of three or more remote operation devices is possible.

Incidentally, the touch detector 5 is provided to each of the remote operation devices.

A detection device identifying unit 12, which is comprised of a semiconductor integrated circuit incorporating a CPU or of a single-chip microcomputer, for example, executes the processing of identifying the remote operation device, a touch of the operator to which is detected with the touch detector 5 among the remote operation devices, that is, the rotary dial 4 and remote control 11. Incidentally, the detection device identifying unit 12 constitutes a detection device identifying unit.

Although it is assumed in FIG. 23 that the components of the operation interface device, that is, the liquid crystal display 1, handy operational display 2, touch panel 3, rotary dial 4, remote control 11, touch detectors 5, detection device identifying unit 12, operation target information storage 6, operation target information acquiring unit 7, image arrangement information storage 8, image arrangement information acquiring unit 9 and image display unit 10 are each comprised of dedicated hardware, all of or part of the operation interface device can be comprised of a computer.

For example, when part of the operation interface device (the detection device identifying unit 12, operation target information storage 6, operation target information acquiring unit 7, image arrangement information storage 8, image arrangement information acquiring unit 9, and image display unit 10) is comprised of a computer, a configuration is possible in which the operation target information storage 6 and image arrangement information storage 8 are constructed on the internal memory or external memory of the computer, and programs describing the processing contents of the detection device identifying unit 12, operation target information acquiring unit 7, image arrangement information acquiring unit 9 and image display unit 10 are stored in the memory of the computer so that the CPU of the computer executes the programs stored in the memory.

Next, the operation will be described.

The touch detector 5 mounted on the rotary dial 4 outputs the detection result of a touch of the operator to the rotary dial 4 as in the foregoing embodiment 1.

The touch detector 5 mounted on the remote control 11 outputs the detection result of a touch of the operator to the remote control 11.

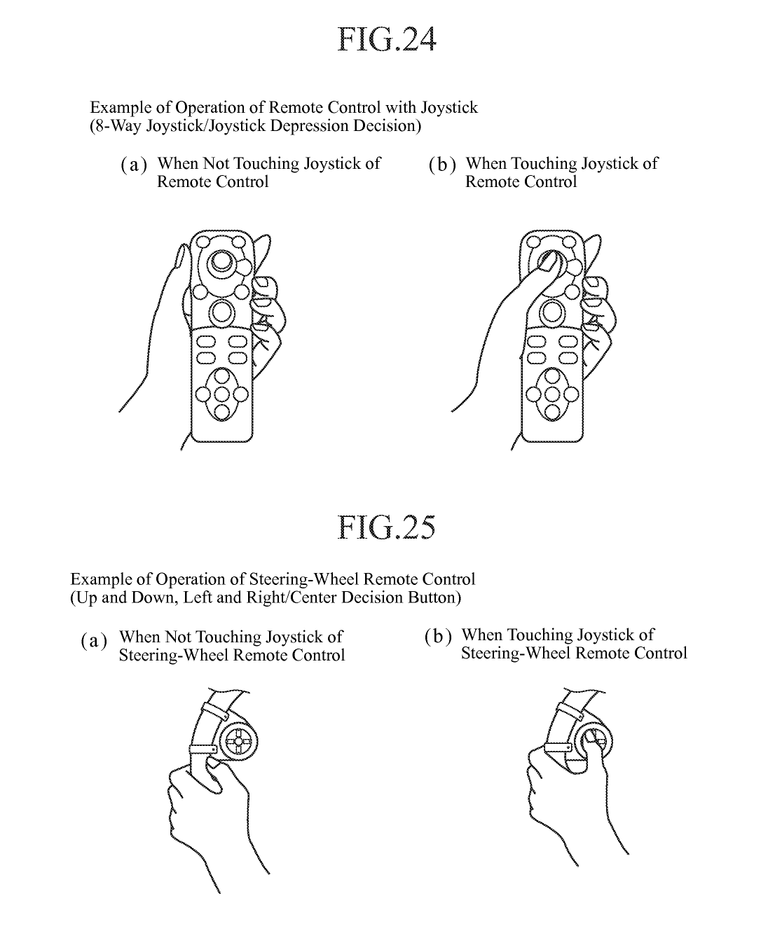

Here, FIG. 24 and FIG. 25 are diagrams illustrating an operation example of a remote control with a joystick.

FIG. 24 and FIG. 25 show a case where the remote control 11 is a remote control with a joystick: FIG. 24 (a) and FIG. 25(a) show a state in which the operator does not touch the joystick of the remote control; and FIG. 24 (b) and FIG. 25(b) show a state in which the operator touches the joystick of the remote control.

The detection device identifying unit 12 receives the detection result output from the touch detector 5 mounted on the rotary dial 4 and the detection result output from the touch detector 5 mounted on the remote control 11, and identifies the remote operation device, the touch of the operator to which is detected with the touch detector 5 between the rotary dial 4 and remote control 11 which are the remote operation devices.

When the detection device identifying unit 12 identifies the remote operation device, the touch of the operator to which is detected with the touch detector 5, it sends the information on whether the remote operation device is the rotary dial 4 or the remote control 11 to the operation target information acquiring unit 7. However, if the operator does not touch to the rotary dial 4 nor the remote control 11, it notifies the operation target information acquiring unit 7 of that.

The operation target information acquiring unit 7 receives the image information indicating the image displayed on the liquid crystal display 1 at present as in the foregoing embodiment 1.

If the operation target information acquiring unit 7 receives the information indicating that the operator does not touch to the rotary dial 4 nor the remote control 11 from the detection device identifying unit 12, it acquires from the operation target information storage 6 the image which is designated by the image information and is in display, and the operation target information corresponding to the touch panel 3 as in the foregoing embodiment 1.

If the operation target information acquiring unit 7 receives the information indicating that the operator touches the rotary dial 4 from the detection device identifying unit 12, it acquires from the operation target information storage 6 the image which is designated by the image information and is in display, and the operation target information corresponding to the rotary dial 4 as in the foregoing embodiment 1.

In addition, if the operation target information acquiring unit 7 receives the information indicating that the operator touches the remote control 11 from the detection device identifying unit 12, it acquires from the operation target information storage 6 the image which is designated by the image information and is in display, and the operation target information corresponding to the remote control 11.

When the operation target information acquiring unit 7 acquires the operation target information, the image arrangement information acquiring unit 9 acquires from the image arrangement information storage 8 the image arrangement information corresponding to the operation target information as in the foregoing embodiment 1.

When the image arrangement information acquiring unit 9 acquires the image arrangement information, and if the image arrangement information is the arrangement information of the touch panel operational image, the image display unit 10 displays the touch panel operational image on the liquid crystal display 1 and handy operational display 2 in accordance with the image arrangement information as in the foregoing embodiment 1.

If the image arrangement information is the arrangement information of the rotary dial operational image, the image display unit 10 displays the rotary dial operational image on the liquid crystal display 1 and handy operational display 2 in accordance with the image arrangement information as in the foregoing embodiment 1.

In addition, if the image arrangement information is the arrangement information of the remote control operational image (remote operation device operational image), the image display unit 10 displays the remote control operational image on the liquid crystal display 1 and handy operational display 2 in accordance with the image arrangement information.

Incidentally, if the operator takes his or her hand off the rotary dial 4 or remote control 11 (if the touch of the operator to the rotary dial 4 or remote control 11 is not detected with the touch detector 5) after the image display unit 10 displays the rotary dial operational image or the remote control operational image on the liquid crystal display 1 and handy operational display 2, the image display unit 10 displays the touch panel operational image on the liquid crystal display 1 and handy operational display 2 after a fixed time period has elapsed.

As is clear from the foregoing description, according to the present embodiment 3, it is configured in such a manner that when the rotary dial 4 and the remote control 11 are installed as the remote operation devices, it comprises the detection device identifying unit 12 that identifies the remote operation device, the touch of the operator to which is detected with the touch detector 5 between the rotary dial 4 and remote control 11, and that when the touch of the operator is detected with the touch detector 5, it displays the remote operation device operational image corresponding to the remote operation device identified with the detection device identifying unit 12 on the liquid crystal display 1 and handy operational display 2. Accordingly, even when a plurality of remote operation devices are installed, it offers an advantage of being able to improve the operability of the touch panel 3 and the plurality of remote operation devices.

### Embodiment 4

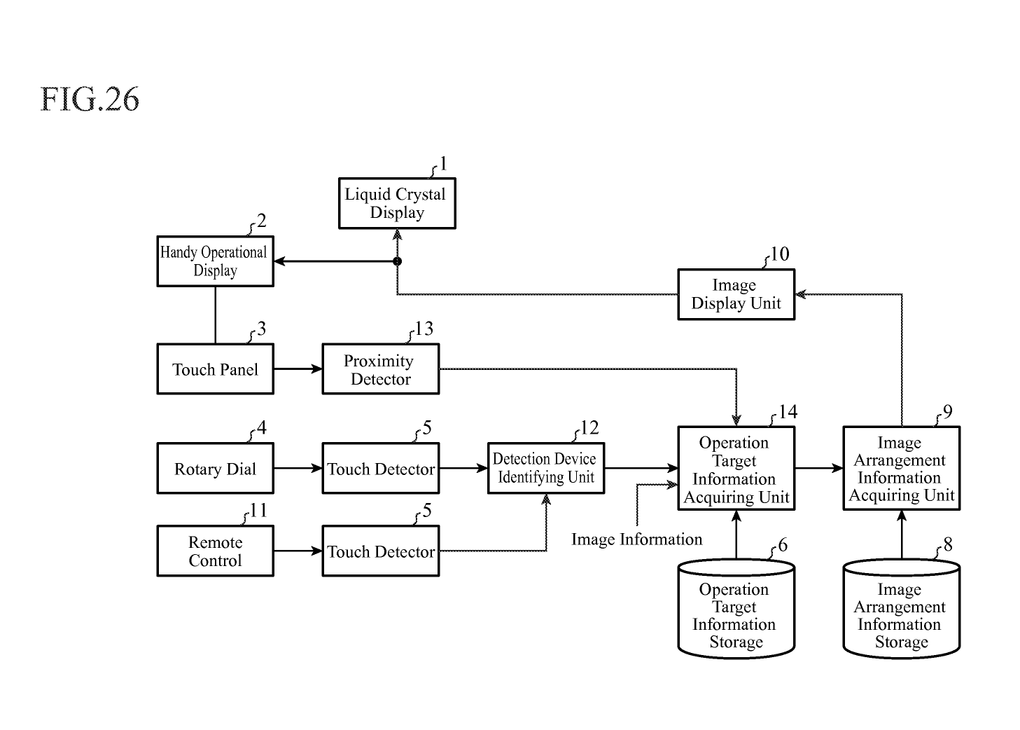

FIG. 26 is a block diagram showing a configuration of an operation interface device of an embodiment 4 in accordance with the present invention. In FIG. 26, since the same reference numerals as those of FIG. 23 designates the same or like components, their description will be omitted.

A proximity detector 13, which is comprised of a capacitance touch sensor, for example, is mounted on the touch panel 3.

The proximity detector 13 detects the approach of an operator to the touch panel 3 because of the fact that the capacitance of the touch sensor goes beyond a prescribed value when the distance between the touch panel 3 and the operator becomes less than a prescribed value.

Incidentally, the proximity detector 13 constitutes a proximity detector.

An operation target information acquiring unit 14, which is comprised of a semiconductor integrated circuit incorporating a CPU, or of a single-chip microcomputer, for example, receives the image information indicating the image displayed on the liquid crystal display 1 at present, and if the approach of the operator is detected with the proximity detector 13, it executes the processing of acquiring from the operation target information storage 6 the image which is designated by the image information and is in display, and the operation target information corresponding to the touch panel 3.

If the operation target information acquiring unit 14 receives the information indicating that the operator touches the rotary dial 4 from the detection device identifying unit 12, it acquires from the operation target information storage 6 the image which is designated by the image information and is in display, and the operation target information corresponding to the rotary dial 4.

In addition, if the operation target information acquiring unit 14 receives the information indicating that the operator touches the remote control 11 from the detection device identifying unit 12, it acquires from the operation target information storage 6 the image which is designated by the image information and is in display, and the operation target information corresponding to the remote control 11.

In addition, if the operation target information acquiring unit 14 receives the information indicating that the approach of the operator is not detected with the proximity detector 13 and that the operator does not touch the rotary dial 4 nor the remote control 11 from the detection device identifying unit 12, it executes the processing of acquiring the operation target information that corresponds to the image which is designated by the image information and is in display, and that is used for displaying a non-operational image which differs from the touch panel operational image nor the remote operation device operational image (the rotary dial operational image or remote control operational image).

Incidentally, the operation target information acquiring unit 14 constitutes an image display unit.

Although it is assumed in FIG. 26 that the components of the operation interface device, that is, the liquid crystal display 1, handy operational display 2, touch panel 3, rotary dial 4, remote control 11, touch detectors 5, detection device identifying unit 12, proximity detector 13, operation target information storage 6, operation target information acquiring unit 14, image arrangement information storage 8, image arrangement information acquiring unit 9 and image display unit 10 are each comprised of dedicated hardware, all of or part of the operation interface device can be comprised of a computer.

For example, when part of the operation interface device (the detection device identifying unit 12, operation target information storage 6, operation target information acquiring unit 14, image arrangement information storage 8, image arrangement information acquiring unit 9, and image display unit 10) is comprised of a computer, a configuration is possible in which the operation target information storage 6 and image arrangement information storage 8 are constructed on the internal memory or external memory of the computer, and programs describing the processing contents of the detection device identifying unit 12, operation target information acquiring unit 14, image arrangement information acquiring unit 9 and image display unit 10 are stored in the memory of the computer so that the CPU of the computer executes the programs stored in the memory.

Next, the operation will be described.

The touch detector 5 mounted on the rotary dial 4 outputs the detection result of a touch of the operator to the rotary dial 4 as in the foregoing embodiment 3.

The touch detector 5 mounted on the remote control 11 outputs the detection result of a touch of the operator to the remote control 11 as in the foregoing embodiment 3.

The detection device identifying unit 12, as in the foregoing embodiment 3, receives the detection result output from the touch detector 5 mounted on the rotary dial 4 and the detection result output from the touch detector 5 mounted on the remote control 11, and identifies the remote operation device, the touch of the operator to which is detected with the touch detector 5 between the rotary dial 4 and the remote control 11 which are the remote operation devices.

When the detection device identifying unit 12 identifies the remote operation device, the touch of the operator to which is detected with the touch detector 5, it sends the information on whether the remote operation device is the rotary dial 4 or the remote control 11 to the operation target information acquiring unit 14. However, if the operator does not touch to the rotary dial 4 nor the remote control 11, it notifies the operation target information acquiring unit 14 of that.

The proximity detector 13 detects the approach of the operator to the touch panel 3 because of the fact that the capacitance of the touch sensor goes beyond the prescribed value when the distance between the touch panel 3 and the operator becomes less than the prescribed value.

The proximity detector 13 supplies the operation target information acquiring unit 14 with the proximity detection result indicating whether the operator is close to the touch panel 3 or not.

The operation target information acquiring unit 14, as the operation target information acquiring unit 7 of FIG. 23, receives the image information indicating the image displayed on the liquid crystal display 1 at present.

If the approach of the operator is detected with the proximity detector 13, the operation target information acquiring unit 14 acquires from the operation target information storage 6 the image which is designated by the image information and is in display, and the operation target information corresponding to the touch panel 3.

If the operation target information acquiring unit 14 receives the information indicating that the approach of the operator is not detected with the proximity detector 13 and that the operator touches the rotary dial 4 from the detection device identifying unit 12, it acquires from the operation target information storage 6 the image which is designated by the image information and is in display, and the operation target information corresponding to the rotary dial 4.

In addition, if the operation target information acquiring unit 14 receives the information indicating that the approach of the operator is not detected with the proximity detector 13 and that the operator touches the remote control 11 from the detection device identifying unit 12, it acquires from the operation target information storage 6 the image which is designated by the image information and is in display, and the operation target information corresponding to the remote control 11.

Here, the example has been described which preferentially acquires, if the approach of the operator is detected with the proximity detector 13, the operation target information corresponding to the touch panel 3 even if the operator touches the rotary dial 4 or remote control 11. However, a configuration is also possible which preferentially acquires the operation target information corresponding to the rotary dial 4 or remote control 11 if the operator touches the rotary dial 4 or remote control 11 even if the approach of the operator is detected with the proximity detector 13.

When the operation target information acquiring unit 14 receives the information indicating that the approach of the operator is not detected with the proximity detector 13 and that the operator does not touch the rotary dial 4 nor the remote control 11 from the detection device identifying unit 12, it acquires the operation target information that corresponds to the image which is designated by the image information and is in display, and that is used for displaying the non-operational image.

As the non-operational image, an image is conceivable which places emphasis on making it easier to see rather than the operability, for example.

In addition, as the non-operational image, an image is conceivable which is intermediate between the touch panel operational image and the remote operation device operational image (rotary dial operational image or remote control operational image). To be concrete, for example, if the touch panel operational image is a three-line display list and the remote operation device operational image is a five-line display list, a non-operational image with a four-line display list is conceivable.

When the operation target information acquiring unit 14 acquires the operation target information, the image arrangement information acquiring unit 9 acquires, as in the foregoing embodiment 3, the image arrangement information corresponding to the operation target information from the image arrangement information storage 8.

When the image arrangement information acquiring unit 9 acquires the image arrangement information, and if the image arrangement information is the arrangement information of the touch panel operational image, the image display unit 10 displays, as in the foregoing embodiment 3, the touch panel operational image on the liquid crystal display 1 and handy operational display 2 in accordance with the image arrangement information.

If the image arrangement information is the arrangement information of the rotary dial operational image, the image display unit 10 displays, as in the foregoing embodiment 3, the rotary dial operational image on the liquid crystal display 1 and handy operational display 2 in accordance with the image arrangement information.

In addition, if the image arrangement information is the arrangement information of the remote control operational image, the image display unit 10 displays, as in the foregoing embodiment 3, the remote control operational image on the liquid crystal display 1 and handy operational display 2 in accordance with the image arrangement information.

In addition, if the image arrangement information is the arrangement information of the non-operational image, the image display unit 10 displays the non-operational image on the liquid crystal display 1 and handy operational display 2 in accordance with the image arrangement information.

Incidentally, when the operator takes his or her hand off the touch panel 3, rotary dial 4 or remote control 11 after displaying the touch panel operational image, rotary dial operational image or remote control operational image on the liquid crystal display 1 and handy operational display 2, and after a fixed time period has elapsed, the image display unit 10 displays the non-operational image on the liquid crystal display 1 and handy operational display 2.

As is clear from the foregoing description, according to the present embodiment 4, it is configured in such a manner that it comprises the proximity detector 13 for detecting the approach of the operator to the touch panel 3, and that it displays, when the approach of the operator is detected with the proximity detector 13, the touch panel operational image suitable for the operation of the touch panel 3 on the liquid crystal display 1 and handy operational display 2, and displays, when the approach of the operator is not detected with the proximity detector 13 and when the touch of the operator is not detected with the touch detector 5, the non-operational image different from the touch panel operational image or from the remote operation device operational image on the liquid crystal display 1 and handy operational display 2. Accordingly, it can improve the operability of the touch panel 3, rotary dial 4 and remote control 11. In addition, in a condition in which the operator does not perform any operation, for example, it offers an advantage of being able to display an image that will make it easier to see rather than improving the operability.

### Embodiment 5

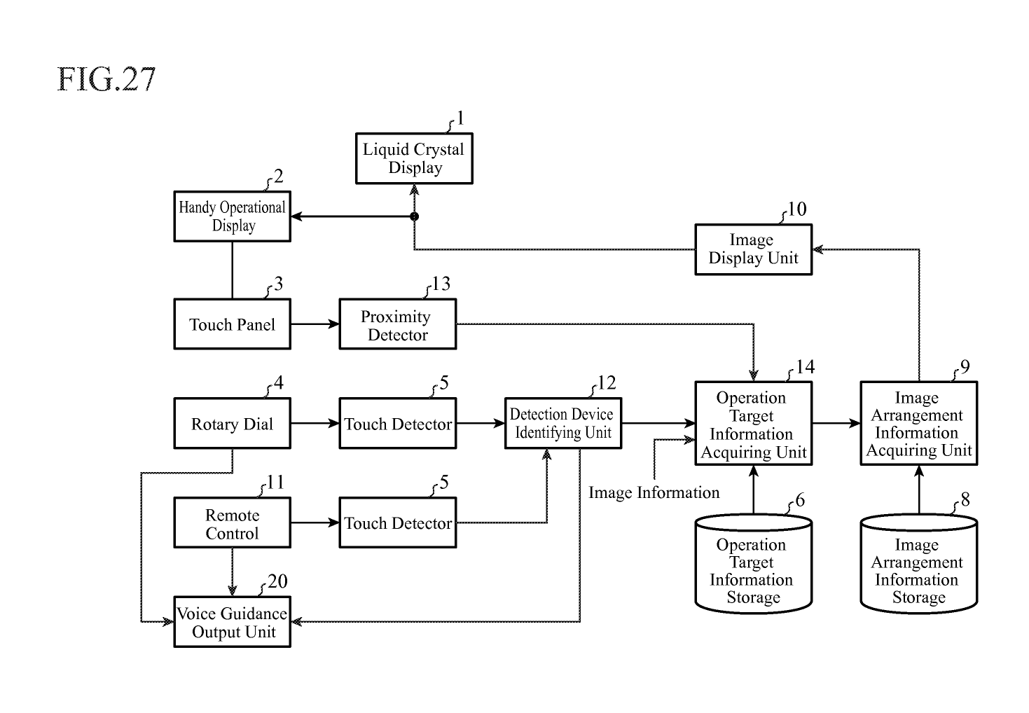

Although the foregoing embodiments 1-4 show an example which displays the remote operation device operational image on the liquid crystal display 1 and handy operational display 2 when a touch of the operator is detected with the touch detector 5, a configuration as shown in FIG. 27 is also possible which comprises a voice guidance output unit 20 (voice guidance output unit) that outputs voice guidance when a touch of the operator is detected with the touch detector 5.

As a configuration of the voice guidance output unit 20, an implement that is comprised of a speech synthesizer and a speaker is conceivable, for example.

As the voice guidance, it is conceivable to employ, for example, guidance that reads out the content of the selected item indicated with the cursor displayed in the remote operation device operational image; guidance indicating that a touch to the rotary dial 4 or the remote control 11 is detected; guidance informing of an operation method of the rotary dial 4 or the remote control 11; or guidance informing of the selectable items with the rotary dial 4 or the remote control 11.

### Embodiment 6

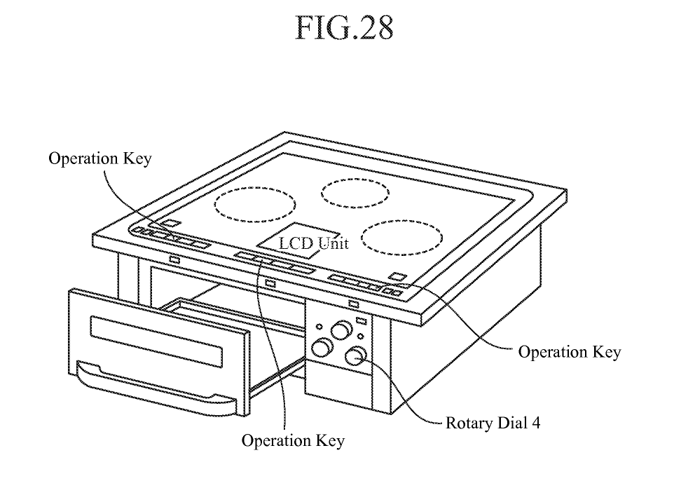

Although the foregoing embodiments 1-5 show an example which incorporates the operation interface device as an onboard operation device, the application of the operation interface device is not limited to the onboard operation device. The operation interface device is also applicable to any apparatuses that involve some operation such as cooking appliances like an induction cooker (IH cooking heater) as shown in FIG. 28 and a microwave oven, electrical appliances like a refrigerator and a washing machine, and FA equipment.

In this connection, as for the induction cooker of FIG. 28, the LCD unit constitutes the handy operational display 2, and the touch panel 3 is mounted on the display surface of the handy operational display 2.

In addition, the induction cooker is equipped not only with the rotary dial 4, but also with a plurality of operation keys (remote operation device), and the rotary dial 4 and a plurality of operation keys comprise a touch detector 5 that detects a touch of the operator.

Incidentally, although the induction cooker of FIG. 28 is a type of the operation interface device without the liquid crystal display 1, a configuration is also possible which uses the liquid crystal display 1 instead of the handy operational display 2 to constitute the LCD unit. In this case, the touch panel 3 is mounted on the display surface of the liquid crystal display 1.

Incidentally, it is to be understood that a free combination of the individual embodiments, variations of any components of the individual embodiments or removal of any components of the individual embodiments is possible within the scope of the present invention.

### INDUSTRIAL APPLICABILITY

An operation interface device in accordance with the present invention uses a plurality of operational interfaces (such as a touch panel, a rotary dial, a remote control etc.) in combination, and is suitable for applications that have to improve the operability of the plurality of operational interfaces.

### DESCRIPTION OF REFERENCE SYMBOLS

1 liquid crystal display (first display); 2 remote operation display (second display); 3 touch panel; 4 rotary dial (remote operation device); 4a knob; 4b touch sensor; 4c rotary encoder; 4d push switch; 5 touch detector (touch detector); 6 operation target information storage (image display unit); 7 operation target information acquiring unit (image display unit); 8 image arrangement information storage (image display unit); 9 image arrangement information acquiring unit (image display unit); 10 image display unit (image display unit); 11 remote control (remote operation device); 12 detection device identifying unit (detection device identifying unit); 13 proximity detector (proximity detector); 14 operation target information acquiring unit (image display unit); 20 voice guidance output unit (voice guidance output unit).

1. An operation interface device comprising:
a display that displays an image;
a touch panel that is mounted on a display surface of the display;
a remote operation device that accepts a remote operation;
a touch detector that detects a touch of an operator to the remote operation device; and
an image display unit that displays, when the touch of the operator is not detected with the touch detector, a touch panel operational image that shows a list of items to be selected in areas or numbers suitable for a selecting operation of an item with the touch panel on the display, and that displays, when the touch of the operator is detected with the touch detector, a remote operation device operational image that shows a list of items to be selected in areas or numbers suitable for a selecting operation of an item with the remote operation device on the display.

2. An operation interface device comprising:
a first display that displays an image;
a second display that displays roughly the same image as the image displayed on the first display;
a touch panel that is mounted on a display surface of the second display;
a remote operation device that accepts a remote operation;
a touch detector that detects a touch of an operator to the remote operation device; and
an image display unit that displays, when the touch of the operator is not detected with the touch detector, a touch panel operational image that shows a list of items to be selected in areas or numbers suitable for a selecting operation of an item with the touch panel on the first and second displays, and that displays, when the touch of the operator is detected with the touch detector, a remote operation device operational image that shows a list of items to be selected in areas or numbers suitable for a selecting operation of an item with the remote operation device on the first and second displays.

3. The operation interface device according to claim 1, wherein
the image display unit displays, when displaying the remote operation device operational image, a cursor that indicates a currently selectable operation item on the display, and conceals the cursor when displaying the touch panel operational image.

4. The operation interface device according to claim 1, wherein
the touch detector outputs a detection result indicating that the operator touches the remote operation device even if the operator does not touch the remote operation device, but if the operator is close enough to the remote operation device with a distance between them not greater than a prescribed value; and
the image display unit displays, when it receives the detection result from the touch detector, the remote operation device operational image that shows a list of items to be selected in areas or numbers suitable for the operation of the remote operation device on the display.

5. The operation interface device according to claim 1, further comprising, when a plurality of remote operation devices are installed:
a detection device identifying unit that identifies the remote operation device, the touch of the operator to which is detected with the touch detector among the plurality of remote operation devices, wherein
the image display unit displays, when the touch of the operator is detected with the touch detector, the remote operation device operational image corresponding to the remote operation device identified with the detection device identifying unit on the display.

6. An operation interface device comprising:
a display that displays an image;
a touch panel that is mounted on a display surface of the display;
a remote operation device that accepts a remote operation;
a touch detector that detects a touch of an operator to the remote operation device;
a proximity detector that detects approach of the operator to the touch panel; and
an image display unit that displays, when the touch of the operator is not detected with the touch detector, a touch panel operational image suitable for an operation of the touch panel on the display, and that displays, when the touch of the operator is detected with the touch detector, a remote operation device operational image suitable for an operation of the remote operation device on the display, wherein
the image display unit displays, when the approach of the operator is detected with the proximity detector, the touch panel operational image suitable for the operation of the touch panel on the display, and displays, when the approach of the operator is not detected with the proximity detector and the touch of the operator is not detected with the touch detector, an image different from the touch panel operational image and from the remote operation device operational image on the display.

7. The operation interface device according to claim 1, further comprising:
a voice guidance output unit that outputs voice guidance when a touch of the operator is detected with the touch detector.

8. The operation interface device according to claim 2, wherein when a touchpad is installed instead of the second display and the touch panel,
the image display unit displays, when the touch of the operator is not detected with the touch detector, a touchpad operational image which is the same image as the touch panel operational image on the first display, and displays, when the touch of the operator is detected with the touch detector, the remote operation device operational image on the first display.

9. An operation interface method comprising:
a touch detection processing step of detecting, with a touch detector, a touch of an operator to a remote operation device that accepts a remote operation; and
an image display processing step of displaying, with an image display unit, when the touch of the operator is not detected at the touch detection processing step, a touch panel operational image that shows a list of items to be selected in areas or numbers suitable for a selecting operation of an item with a touch panel mounted on a display surface of a display on the display, and displays, when the touch of the operator is detected at the touch detection processing step, the remote operation device operational image that shows a list of items to be selected in areas or numbers suitable for a selecting operation of an item with the remote operation device on the display.
